(19) United States
(12) Patent Application Publication
(10) Pub. No.: US 2011/0219775 A1
(43) Pub. Date: Sep. 15, 2011

(54) HIGH TOLERANCE CONTROLLED SURFACE FOR CERAMIC MATRIX COMPOSITE COMPONENT

(76) Inventors: David C. Jarmon, Kensington, CT (US); Steven Lozyniak, South Windsor, CT (US); Tania Bhatia, Middletown, CT (US)

(21) Appl. No.: 12/722,899

(22) Filed: Mar. 12, 2010

(51) Int. Cl. F23R 3/42; C23C 4/04; B32B 18/00

(52) U.S. Cl. 60/753; 427/452; 428/446

(57) ABSTRACT

A ceramic matrix composite (CMC) component includes a hardenable material that can be machined to provide a desired dimension and surface finish.

The subject of this disclosure was made with government support under Contract No.: N00014-06-C-0585 awarded by the Navy. The government therefore may have certain rights in the disclosed subject matter.

### BACKGROUND

This disclosure generally relates process for creating a desired surface finish and dimension for a ceramic matrix composite component.

A ceramic matrix composite includes a fiber reinforcement layer saturated with ceramic material. The ceramic matrix composite is utilized to provide desirable mechanical and thermal properties. Typical ceramic matrix components provide thermal properties that are favorable for high temperature environments. The fiber reinforcement layer provides desired mechanical properties and improves durability. Including the fiber reinforcement layer further improves the durability properties of the ceramic matrix composite as compared to a purely ceramic component. The fiber reinforcement layer while improving the durability of the ceramic component contributes to the creation of rough surface finishes and inconsistent dimensional control.

### SUMMARY

A disclosed ceramic matrix composite (CMC) component includes a hardenable material applied to a surface of the CMC such that at least a portion of the CMC can be machined to provide a desired dimension and surface finish.

The example disclosed process includes the application of a hardenable material such as silicon to areas where a precise dimensional tolerance is desired. The hardenable material can then be machined to provide the desired geometry within acceptable dimensional tolerances.

Accordingly, the example process provides for the use of CMC components in an increased range of applications that require dimensional tolerances beyond those consistently obtained with CMC material fabrication processes.

These and other features disclosed herein can be best understood from the following specification and drawings, the following of which is a brief description.

### BRIEF DESCRIPTION OF THE DRAWINGS

FIG. 1 is a schematic view of an example gas turbine engine including an example ceramic matrix composite component.

FIG. 2 is a schematic view of an example ceramic matrix composite component.

FIG. 3 is a schematic view of an example ceramic matrix composite component held in place by a support member.

FIG. 4 is a schematic view of a method of forming a ceramic matrix composite component.

### DETAILED DESCRIPTION

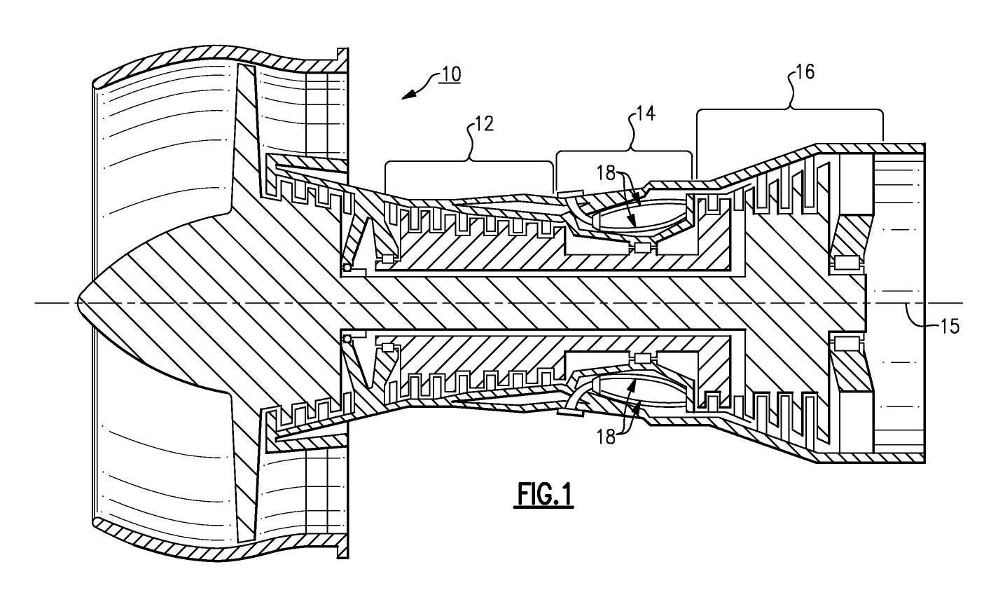

Referring to FIG. 1, a gas turbine engine 10 includes a compressor section 12 that feeds compressed air to a combustor 14. In the combustor 14, the compressed air is mixed with fuel and ignited to generate a stream of hot gases. The generated stream of hot gases drive a turbine section 16 that in turn drives the compressor section 12. The combustor 14 includes an inner liner 18 that is formed and configured to endure the high temperatures produced during combustion.

The example liner 18 is formed from a ceramic matrix composite material that provides the desired favorable thermal properties. As appreciated, the illustrated gas turbine engine 10 is one of many known gas turbine engine configurations that will benefit from the following disclosure. The example liner 18 includes different components exposed to the extreme temperatures generated during combustion.

Referring to FIG. 2, a disclosed example component 20 comprises a ceramic matrix composite (CMC) portion 22 comprised of reinforcement fibers 24 intermixed with a ceramic material 26. The example CMC material comprises a silicon carbide material produced by a chemical vapor infiltration process. The reinforcement fibers 24 provide an increased durability and strength that are desirable for many applications. The inclusion of the reinforcement fibers 24 also presents dimensional control limitations for the size and surface finish.

The reinforcement fibers 24 provide the increased strength and durability that is desired, but also inhibits significant machining or other secondary operations that could be implemented to accommodate limitations in dimensional control. Machining or any other cutting or material removal processes that are successfully utilized for other materials are of limited success for use with CMC materials. The example component includes a layer of hardenable material 38 that is bonded to a surface of the CMC 22. The example hardenable material 38 is comprised of silicon and can be machined to provide a desired dimension and surface finish.

The hardenable material includes at least one typical constituent of an environmental barrier coating (EBC). This includes at least one of silicon, refractory metal silicides, barium strontium aluminosilicate (BSAS), strontium aluminosilicate (SAS), yttrium silicates. Rare earth silicates, mullite, hafnium oxide, tantalum oxide, hafnium silicate, zirconium silicate. The hardenable material may be reinforced with chopped fibers or hard or soft ceramic particles. The reinforcements might include carbides, graphite, carbon, glass, silicon carbide, silicon nitride or boron nitride.

The hardenable material may be applied by any method of coating application known in the art. These include plasma spraying techniques such as vacuum plasma spray(VPS) and air plasma spray (APS); physical vapor deposition methods such as electron-beam physical vapor deposition (EBPVD), slurry approaches and pack-cementation methods, chemical vapor demosition etc.

The process and material utilized to produce the CMC portion 22 result in a surface deviation of approximately +/−0.004″ (+/−0.1016 mm) or greater. In this example, the silicon layer 38 is applied in areas where a more precise dimensional tolerance is desired. In this example the silicon layer 38 is applied to a portion of the component 20 where an overall thickness indicated at 32 is desired. Such a thickness may be required for areas of the component that must interface accurately with other members.

In this example, the component thickness 32 is formed from a first thickness 44 of the CMC 22 and a second thickness 42 that is formed from the silicon layer 38. The silicon layer 38 provides a surface that can be machined to desired tolerances. The silicon layer 38 provides a layer that is machinable without disturbing the matrix composition of the CMC 22.

The silicon layer 38 is applied in a non-solid form to a surface 30 of the CMC 22 and becomes solid upon cooling. The silicon layer 38 forms a bond to the surface 30 with a tensile strength substantially the same as the CMC 22. That is, the bond between the silicon layer 38 and the CMC 22 withstands tensile forces that are substantially the same as if the CMC 22 material were tested by itself. The bond 44 between the silicon layer 38 and the CMC 22 is therefore not a weak point in the component 20.

The silicon material layer 38 does not include continuous reinforcement fibers and therefore can be machined to provide a desired shape, thickness and surface finish. In the example component, a machined surface 40 of the silicon layer 38 includes a surface deviation that is much less than that of the surface deviation of the surface 30. Moreover, the example machined surface is machinable to a thickness within a desired tolerance range of +/−0.002″ (+/−0.0508 mm) or better.

Machining of the layer 38 can be performed using any known machining process. As appreciated, a desired tolerance of a desired dimension will govern the specific machining process utilized. In the example component 20, the silicon layer 38 is machined using a diamond grinding operation to provide the desired thickness 32. The example machining process provides for the creation of a machine surface within a tolerance of +/−0.002″ (+/−0.0508 mm) or better. Of course other machining processes and grinding operations are within the contemplation of this disclosure.

A CMC part is desirable for use in applications that encounter extreme temperatures. The thermal performance provided by CMC parts make it favorable for use shielding other less thermally resistant parts such as for example the combustor liner 18 (FIG. 1). As appreciated, the combustor liner 18 encounters extreme temperatures on a hot side 28 as compared to a cold side 30. The silicon layer 38 is applied to the cold side 30 such that it is not exposed to the temperature extremes encountered by the hot side 18.

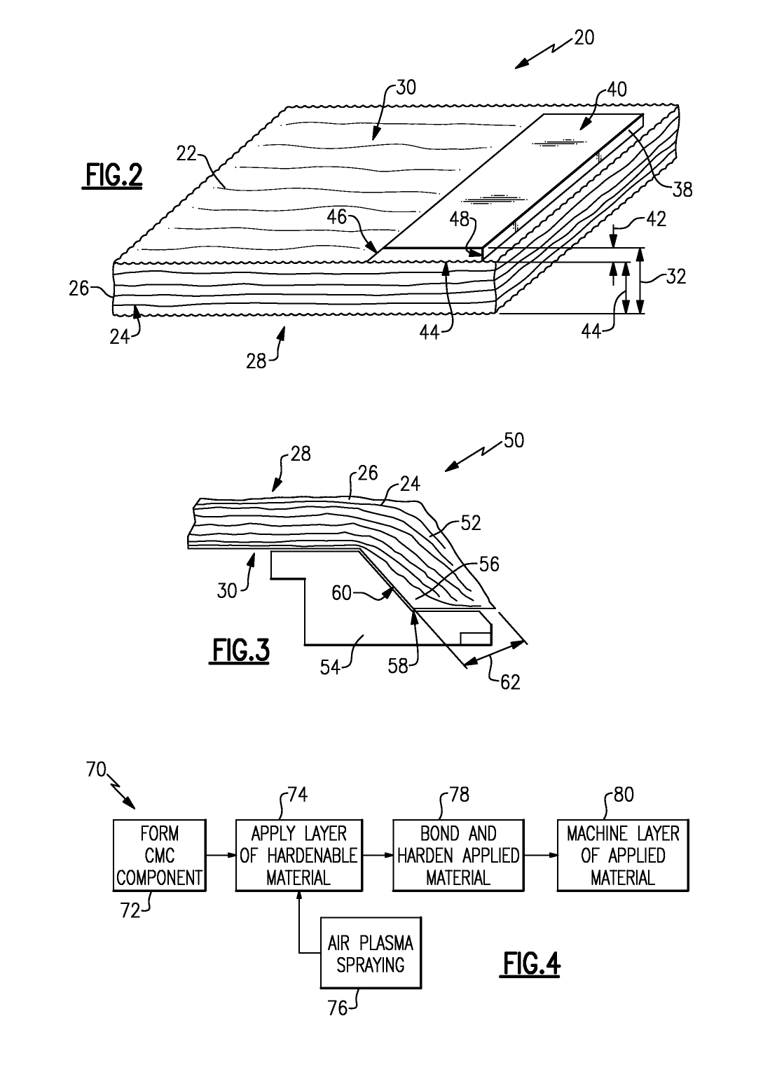

Referring to FIG. 3, another example component 50 is a part of a combustor and is exposed to the hot gas flow produced during combustion. As appreciated, although a combustor liner is disclosed, the component 50 could be utilized in any environment requiring a desired thermal performance. The example component 50 includes a CMC part 52 that is supported and held in place by a metal support member 54. An interface 58 between the metal support member 54 and the CMC part 52 is desired to include a specific geometry to facilitate support against flow forces and to accommodate thermal loading or other conditions that are encountered during operation.

The inconsistent fabrication process of forming the CMC part 52 may not provide consistent results within desired tolerance limits. Therefore, in this example, a silicon layer 56 is applied at the interface 58. The silicon layer 56 is applied as a layer to form a complete overall dimension greater than a desired final dimension, such as for example a desired thickness 62. The silicon layer 56 is then machined to provide the thickness 62 within acceptable tolerance limits. In this example, the silicon layer 56 forms a substantial part of the interface surface 60 that abuts the metal support 54. Moreover, as shown the silicon layer 56 itself varies in thickness to accommodate inconsistencies in the CMC 52 part.

Referring to FIG. 4, the process of fabricating an example CMC component is schematically shown at 70 and includes the initial step of forming the CMC component as indicated at 72. Formation of the CMC can be accomplished by any known method. The example process utilizes a chemical vapor infiltration process that forms the ceramic matrix composite with the fiber reinforcement layers 24.

The example CMC is melt infiltrated silicon carbide/silicon carbide (MI SiC/SiC) which consists of a silicon carbide (SiC) fiber, a boron nitride (BN) fiber/matrix interface, and a silicon-silicon carbide (Si—SiC) matrix. Chemical vapor infiltration (CVI) is used to apply the BN interface, along with a SiC overcoat. Final densification of the matrix is completed by slurry cast (SC) and melt infiltration (MI) processes that result in a Si—SiC matrix. It should be understood that other methods and material known for producing a ceramic matrix composite material are within the contemplation of this disclosure.

Once the CMC part is complete, the surface deviation for specific areas of the component may not be as desired. Therefore a layer of hardenable material, such as Silicon in this disclosed example, is applied to a surface of the CMC part as is indicated at 74. The layer of silicon can be applied to localized areas that comprise an interface with other components, or to a larger general area to provide a desired surface finish better than that produced by the CMC formation process. The layer of silicon is therefore applied to locations of the CMC where the desired final dimensions are not consistently obtainable with the CMC process alone. In the disclosed examples, the silicon layers 38 (FIG. 2) and 56 (FIG. 3) are applied in areas that interface with other components, such as the support member 54.

The example application process includes an air plasma spraying process as is indicated at 76. In an air plasma spraying process, silicon is applied in a non solid form in the presence of heat. Layers of silicon are applied sequentially to build up a sufficient thickness to provide sufficient material for machining to a desired completed dimension. Other application processes as are known could also be utilized for applying a layer of hardenable material of sufficient desired thickness.

Once the hardenable material is applied, the hardenable material will bond to the CMC material and harden as is indicated at 78. The desired bond between the silicon material and the CMC material is such that desired mechanical properties of the completed part are maintained.

With the silicon applied, bonded and hardened, the silicon layer can then be machined to provide the desired dimensions as is indicated at 80. In the disclosed examples, the silicon layers 38 (FIG. 2) and 56 (FIG. 3) are machined to provide an interface with another component. The silicon layer 38 is machined to provide a desired overall thickness of the CMC component 20 within a desired tolerance. Further, edges of the silicon layer 38 can either be angled as indicated at 46 (FIG. 2) or transverse as indicated at 48. Moreover, the silicon layer could also be machined to provide a specific geometry as is shown in FIG. 3.

The example machining process includes a diamond grinding operation that provides a desired surface finish and dimensional tolerance. As appreciated, the specific machining operation utilized can be varied as required to generate a desired tolerance and geometry. Once the machining processes are complete, the CMC component provides the desired thermal properties combined with the desired geometry within desired dimensional tolerance range. Other machining processes including ultrasonic machining and grinding may be used to achieve the desired dimensional control.

The example process provides for the use of CMC components in an increased range of applications that require dimensional tolerances beyond those consistently obtained with CMC material fabrication processes.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of fabricating a ceramic matrix composite component comprising the steps of:
forming a ceramic matrix composite component into a desired shape including a fiber reinforced layer;
applying a layer of material to a surface of the component, wherein the material is bondable to the ceramic matrix composite; and
machining the layer of material to provide a desired dimension of the ceramic matrix component.

2. The method as recited in claim 1, wherein the step of applying includes applying material in a form other than solid form and that hardens into a solid form after application to the ceramic matrix component.

3. The method as recited in claim 2, including the step of hardening the material applied in a form other than solid into a solid form such that the hardenable material bonds to the ceramic matrix composite.

4. The method as recited in claim 1, wherein the layer of material comprises silicon.

5. The method as recited in claim 4, wherein the silicon is air plasma sprayed onto the surface of the ceramic matrix composite.

6. The method as recited in claim 1, including the step of forming a desired dimension of the component by machining the layer of applied material to create the desired dimension, wherein the desired dimension includes a thickness of the ceramic matrix composite and the layer of applied material.

7. The method as recited in claim 1, wherein the layer of applied material comprises an interface surface for mounting the ceramic matrix component.

8. The method as recited in claim 7, wherein the applied layer of material is layered in a defined area on the ceramic matrix component forming a pad of the applied material.

9. The method as recited in claim 1, wherein the ceramic matrix composite comprises silicon carbon material.

10. The method as recited in claim 1, wherein the applied material is applied to one side of the ceramic matrix composite material.

11. The method as recited in claim 1, wherein the layer of applied material is formed to a thickness greater than a final finished thickness, and the machining step comprises the step of removing a portion of the applied material to form a desired thickness of the component.

12. The method as recited in claim 10, wherein the desired thickness comprises a thickness within a tolerance range less than a surface deviation of a surface of the ceramic matrix composite.

13. A ceramic matrix component comprising:
a ceramic matrix composite material that forms a first portion of a desired completed component shape; and
a hardenable material bonded to the ceramic matrix component forming a second portion of the desired completed component shape, the hardenable material comprising a material different than the materials forming the ceramic matrix composite.

14. The component as recited in claim 13, wherein the component includes an interface surface for securing the component, at least some portion of the hardenable material comprising a portion of the interface.

15. The component as recited in claim 14, wherein the hardenable material comprises a silicon material applied to a surface of the ceramic matrix composite.

16. The component as recited in claim 14, wherein the hardenable material comprises a machined surface of the composite part.

17. The component as recited in claim 14, wherein the hardenable material comprises a surface finish having a surface deviation less than a surface finish of the ceramic matrix composite.

18. The component as recited in claim 14, wherein the bond between the hardenable material and the ceramic matrix composite is of a strength at least equal to the that of the ceramic matrix composite.

19. A combustor for a gas turbine engine comprising:
a housing defining an inner cavity; and
a liner supported within the inner cavity, the liner including a ceramic matrix composite material that forms a first portion of a desired completed shape and a hardenable material different than the ceramic matrix composite material bonded to the ceramic matrix component forming a second portion of the desired completed shape.

20. The combustor as recited in claim 19, wherein the ceramic matrix composite material includes a hot side that is exposed to hot gases produced during combustion and a cold side not directly exposed to the hot gases, and the hardenable material is applied to a cold side of the ceramic matrix composite material.

21. The combustor as recited in claim 19, including a support structure for holding the liner within the inner cavity, the support structure including a surface in abutting contact with a surface of the liner including the hardenable material.

22. The combustor as recited in claim 19, wherein the hardenable material comprises silicon.
